(19) United States
(12) Patent Application Publication
(10) Pub. No.: US 2024/0122241 A1
(43) Pub. Date: Apr. 18, 2024

(54) ELECTRONIC CIGARETTE ATOMIZER

(71) Applicant: SHENZHEN INFEITE TECHNOLOGY CO., LTD., Shenzhen (CN)

(72) Inventor: LIQIAN CHEN, Yiyang (CN)

(21) Appl. No.: 17/964,881

(22) Filed: Oct. 12, 2022

(51) Int. Cl. A24F 40/42; A24F 7/02; A24F 40/485; A24F 40/51; A24F 40/90; H01M 50/202; H01M 50/247; H01M 50/284

(52) U.S. Cl. CPC A24F 40/42; A24F 7/02; A24F 40/485; A24F 40/51; A24F 40/90; H01M 50/202; H01M 50/247; H01M 50/284; H01M 2220/30

(57) ABSTRACT

An electronic cigarette atomizer includes a housing body, a cigarette holder, and a base. A battery bin and a cigarette cartridge bin are disposed in the housing body. A battery is detachably disposed in the battery bin. A first opening communicating with the battery bin and the cigarette cartridge bin is defined at a first end of the housing body. A second opening communicating with the cigarette cartridge bin is defined at a second end of the housing body. The cigarette holder communicating with the second opening is detachably disposed at one end, close to the second opening, of the housing body. A printed circuit board (PCB) is disposed in the base. An ejector pin is connected to the PCB. A mounting hole is further defined on the base. The mounting hole is configured to detachably mount a cigarette cartridge.

### TECHNICAL FIELD

The present disclosure relates to a technical field of atomizers, and in particular to an electronic cigarette atomizer.

### BACKGROUND

Electronic cigarettes are electronic products that mimics cigarettes and have same appearance, smoke, taste and feeling as the cigarettes. The electronic cigarettes are products that turns nicotine into vapor through atomization and other means for users to smoke.

Currently, on the market, cigarette cartridges are generally installed into atomizers of the electronic cigarettes, and when the users smoke, the atomizers control the cigarette cartridges to atomize to generate smoke. However, in order to facilitate installation and replacement of the cigarette cartridges, the cigarette cartridges are generally exposed outside the atomizers and may not be prevented from falling.

### SUMMARY

The present disclosure provides an electronic cigarette atomizer to solve above technical problems.

The electronic cigarette atomizer includes a housing body, a cigarette holder, and a base.

A battery bin and a cigarette cartridge bin are respectively disposed in the housing body. A battery is detachably disposed in the battery bin. A first opening is defined at a first end of the housing body. The first opening is communicated with the battery bin and the cigarette cartridge bin. A second opening is defined at a second end of the housing body. The second opening is communicated with the cigarette cartridge bin.

The cigarette holder is disposed at one end, close to the second opening, of the housing body. The cigarette holder is communicated with the second opening.

A printed circuit board (PCB) is disposed in the base. An ejector pin is connected to the PCB. The ejector pin protrudes out of the base. A mounting hole is further defined on the base. The mounting hole is configured to mount a cigarette cartridge. An air inlet hole is further defined on the base. The air inlet hole is communicated with the mounting hole.

When the cigarette cartridge is disposed in the mounting hole, the cigarette cartridge is in contact with the PCB.

When the base is disposed at one end, close to the first opening, of the housing body, the ejector pin is in contact with the battery, and the cigarette cartridge is just located in the cigarette cartridge bin.

According to the electronic cigarette atomizer, the base and the housing body are detachably disposed, and the mounting hole is defined on the base to detachably mount the cigarette cartridge, so as to fix the cigarette cartridge. The cigarette cartridge bin is disposed in the housing body to contain the cigarette cartridge, so as to hidden and protect the cigarette cartridge. Therefore, according to above mode, the cigarette cartridge is fixed through the base, and the cigarette cartridge is protected through the housing body, so that the cigarette cartridge is conveniently replaced and is further prevented from falling off.

Furthermore, a magnet is disposed on the housing body and/or the base. The base is detachably connected to the housing body through the magnet.

Furthermore, a cavity is defined in the base. The cavity is communicated with the air inlet hole and the mounting hole. The electronic cigarette atomizer further includes a microphone. The microphone is disposed in the cavity. The microphone is electrically connected to the PCB. The microphone is configured to sense airflow entering the air inlet hole.

Furthermore, a mounting groove is defined in the cavity of the base. The microphone is disposed in the mounting groove. An air outlet hole is defined on the base. The air outlet hole is communicated with the mounting groove. When the base is disposed on the housing body, the air outlet hole is communicated with the first opening with respect to the cigarette cartridge bin. A part of the airflow entering from the air inlet hole is discharged out of the base from the air outlet hole after passing through the microphone. A gap is defined between a side wall of the cigarette cartridge and an inner wall of the cigarette cartridge bin. The gap is communicated with the first opening and the second opening.

Furthermore, an extending portion opening is further defined in a position, with respect to the cigarette cartridge bin, of the first opening. The extending portion opening is communicated with the cigarette cartridge bin. When the base is disposed on the housing body, the air outlet hole is communicated with the extending portion opening, and the airflow exhausted by the air outlet hole enters the gap through the extending portion opening.

Furthermore, the housing body includes a support and a housing. The battery bin and the cigarette cartridge bin are respectively disposed on the support. The cigarette cartridge bin is of a full-surrounding structure. The battery bin is of a semi-surrounding structure. The housing is sleeved on the support, and the housing is configured to surround the support.

Furthermore, a sealing ring is disposed on an outer wall of the base. When the base is disposed on the housing body, the sealing ring is located between the outer wall of the base and an inner wall of the housing.

Furthermore, a charging port and/or a key are further disposed on the base. The charging port and/or the key are respectively electrically connected to the PCB.

Furthermore, the air inlet hole is defined between an outer wall of the charging port and/or the key and the base.

Furthermore, the cigarette holder is connected to the housing body in a buckled mode.

### BRIEF DESCRIPTION OF DRAWINGS

In order to more clearly illustrate technical solutions in embodiments of the present disclosure, drawings required in description of the embodiments or prior art are briefly described below. Obviously, the drawings in the following description are merely some embodiments of the present disclosure, and for a person with ordinary skill in the prior art, other drawings are obtained according to the drawings without creative efforts.

FIG. 1 is an exploded schematic diagram of a housing body and a base in an electronic cigarette atomizer according to one embodiment of the present disclosure.

FIG. 2 is a sectional schematic diagram of the electronic cigarette atomizer according to one embodiment of the present disclosure.

Reference number in the drawings: 100. housing body; 110. battery bin; 120. cigarette cartridge bin; 130. battery; 140. cigarette cartridge; 150. first opening; 160. second opening; 170. gap; 180. extending portion opening; 190a. support; 190b. housing;
200. base; 210. PCB; 220. ejector pin; 230. mounting hole; 240. air inlet hole; 250. microphone; 260. mounting groove; 270. air outlet hole; 280. sealing ring; 290a. charging port; 290b. key; 300. cigarette holder; 400. atomizing airflow; 500. switch airflow.

### DETAILED DESCRIPTION

In order to make technical problems to be solved, technical solutions and beneficial effects of the present disclosure clearer, the present disclosure is further described in details below with reference to accompanying drawings and embodiments. It should be understood that the specific embodiments described herein are merely configured to explain the present disclosure, and are not intended to limit the present disclosure.

It should be noted that when an element is referred to as being “fixed to” or “disposed on” another element, it is directly on the other element or indirectly on the other element. When an element is referred to as being “connected to” another element, it is directly connected to the other element or indirectly connected to the other element.

It should be understood that an orientation or a positional relationship indicated by terms “length”, “width”, “upper”, “lower”, “front”, “rear”, “left”, “right”, “vertical”, “horizontal”, “top”, “bottom”, “inner”, “outer”, etc., is based on the orientation or the positional relationship shown in the accompanying drawings, and is merely for convenience of describing the present disclosure and simplifying description, rather than indicating or implying that an indicated apparatus or an element has a specific orientation, is constructed and operated in a specific orientation. Therefore, the terms cannot be understood as a limitation to the present disclosure.

In addition, terms “first” and “second” are merely configured to describe purposes and cannot be understood as indicating or implying relative importance or implicitly indicating the number of indicated technical features. Thus, the features defined with “first” and “second” may explicitly or implicitly include one or more of the features. In the description of some embodiments, “a plurality of” means two or more than two, unless specified otherwise.

The present disclosure provides an electronic cigarette atomizer. Electronic cigarettes are configured to atomize tobacco tar to generate smoke for users to smoke.

In some electronic cigarettes capable of replacing cigarette cartridges, smoke generated by working atomization of the cigarette cartridge is controlled through an electronic cigarette atomizer, including a battery, a PCB, etc., and after the tobacco tar in the cigarette cartridge is atomized, the cigarette cartridge should be replaced with a new cigarette cartridge.

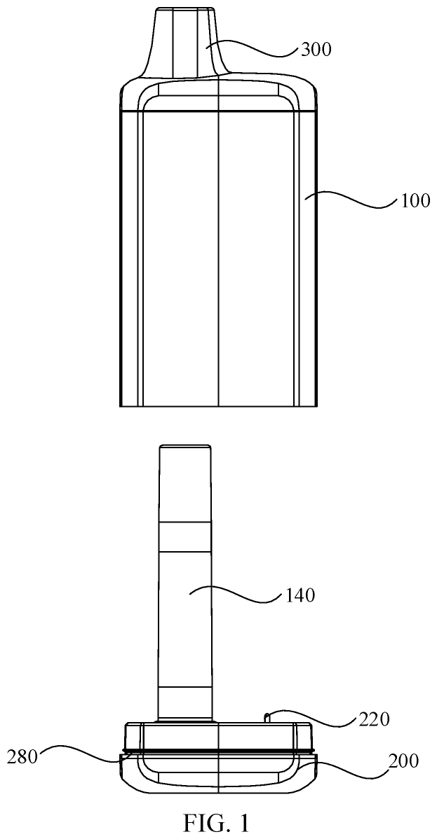

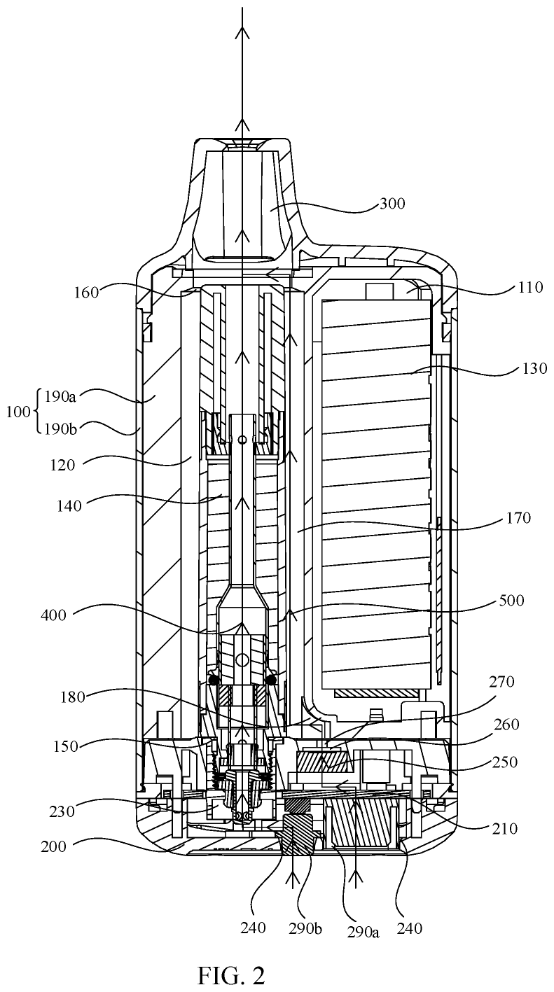

Referring to FIGS. 1-2, the electronic cigarette atomizer includes a housing body 100, a cigarette holder 300, and a base 200. The cigarette holder 300 and the base 200 are respectively disposed on the housing body 100.

Furthermore, a battery bin 110 and a cigarette cartridge bin 120 are disposed in the housing body 100. A battery 130 is detachably disposed in the battery bin 110. A first opening 150 is defined in a first end of the housing body 100. The first opening 150 is communicated with the battery bin 110 and the cigarette cartridge bin 120. A second opening 160 is defined in a second end of the housing body 100. The second opening 160 is communicated with the cigarette cartridge bin 120.

The embodiment further provides two first openings 150, one of the two first openings 150 is communicated with the battery bin 110, the other one of the two first openings 150 is communicated with the cigarette cartridge bin 120, and sizes and shapes of the two first openings 150 are inconsistent.

Of course, in some embodiments, one first opening 150 is provided, and the first opening 150 is simultaneously communicated with the cigarette cartridge bin 120 and the battery bin 110.

The cigarette holder 300 is disposed at one end, close to the second opening 160, of the housing body 100. When the cigarette holder 300 is disposed on the housing body 100, a channel in the cigarette holder 300 is communicated with the second opening 160.

The cigarette holder 300 and the housing body 100 are connected through buckles.

A PCB (Printed Circuit Board) 210 is disposed in the base 200. An ejector pin 220 is disposed on the PCB 210. The ejector pin 220 protrudes out of the base 200. In addition, a mounting hole 230 is defined on the base 200. A cigarette cartridge 140 is detachably mounted in the mounting hole 230. An air inlet hole 240 is further defined on the base 200. The air inlet hole 240 is communicated with the mounting hole 230.

The mounting hole 230 is a threaded through hole, and the cigarette cartridge 140 is detachably connected to the mounting hole 230 in a threaded connection mode.

Specifically, when the cigarette cartridge 140 is disposed in the mounting hole 230, the cigarette cartridge 140 is in contact with the PCB 210, and the PCB 210 controls opening or closing of the cigarette cartridge 140.

When the base 200 is disposed at one end, close to the first opening 150, of the housing body 100, the ejector pin 220 is just in contact with the battery 130 in the battery bin 110, and the cigarette cartridge 140 is just located in the cigarette cartridge bin 120.

During actual use, first detaching the base 200 from the housing body 100, and then connecting an air inlet end of the cigarette cartridge 140 to the mounting hole 230, so that the cigarette cartridge 140 is fixed on the base 200 and is in contact with the PCB 210. The cigarette cartridge 140 is in contact with the PCB 210 through conventional means, such as through positive and negative elastic needles, which is not described in details herein. Then, extending the cigarette cartridge 140 into the cigarette cartridge bin 120 in the housing body 100, and the base 200 is connected to the housing body 100 to complete installation or replacement of the cigarette cartridge 140.

When a user inhales, external airflow sequentially enters the cigarette cartridge 140 through the air inlet hole 240 and the mounting hole 230, and smoke generated in the cigarette cartridge 140 is sucked by the user along with the airflow through the second opening 160 and the cigarette holder 300.

According to the electronic cigarette atomizer, the base 200 and the housing body 100 are detachably disposed, and the mounting hole 230 is defined on the base 200 to detachably mount the cigarette cartridge 140, so as to fix the cigarette cartridge 140. The cigarette cartridge bin 120 is disposed in the housing body 100 to contain the cigarette cartridge 140, so as to hidden and protect the cigarette cartridge 140. Therefore, according to above mode, the cigarette cartridge 140 is fixed through the base 200, and the cigarette cartridge 140 is protected through the housing body 100, so that the cigarette cartridge 140 is conveniently replaced and is further prevented from falling off.

Furthermore, a detachable connection between the housing body 100 and the base 200 is specifically achieved by providing a magnet on the housing body 100 and/or the base 200, where the magnet is not shown in the figures. The base 200 is detachably connected to the housing body 100 through the magnet, so that the base 200 is more convenient to disassemble.

Of course, in other embodiments, the base 200 and the housing body 100 are further detachably connected through threads or buckles.

Referring to FIG. 2, a cavity is defined in the base 200, and the cavity is respectively communicated with the air inlet hole 240 and the mounting hole 230.

It can be understood that an interior of the base 200 is made into a cavity structure, on one hand, the PCB 210 is convenient to accommodate, on the other hand, the air inlet hole 240 is convenient to communicate with the mounting hole 230, and an air channel does not need to be additionally disposed. The air inlet hole 240 and the mounting hole 230 are connected only through a structure such as the gap between the PCB 210 and an inner wall of the base 200, which makes structure of the whole base 200 simpler.

Furthermore, the electronic cigarette atomizer further includes a microphone 250. The microphone 250 is disposed in the cavity. The microphone 250 is electrically connected to the PCB 210. The microphone 250 is configured to sense airflow entering the air inlet hole 240.

When the user sucks, the external airflow enters the cavity through the air inlet hole 240, and after the microphone 250 senses the airflow, the PCB 210 controls the cigarette cartridge 140 to work.

Furthermore, a mounting groove 260 is defined in the cavity of the base 200. The microphone 250 is disposed in the mounting groove 260. An air outlet hole 270 is defined on the base 200. The air outlet hole 270 is communicated with the mounting groove 260. When the base 200 is disposed on the housing body 100, the air outlet hole 270 is communicated with the first opening 150 with respect to the cigarette cartridge bin 120.

Specifically, a part of the airflow entering from the air inlet hole 240 is discharged out of the base 200 from the air outlet hole 270 after passing through the microphone 250 and enters the first opening 150, and other airflow enters the cigarette cartridge 140 through the mounting hole 230.

In addition, when the cigarette cartridge 140 is located in the cavity of the cigarette cartridge 140, a gap 170 is reserved between a side wall of the cigarette cartridge 140 and an inner wall of the cigarette cartridge bin 120. The gap 170 is communicated with the first opening 150 and the second opening 160.

Specifically, the part of the airflow entering the air inlet hole 240 is discharged out of the base 200 from the air outlet hole 270 after passing through the microphone 250 and enters the gap 170 through the first opening 150, and then the part of the airflow is discharged through the second opening 160. The other airflow enters the cigarette cartridge 140 through the mounting hole 230. Smoke generated in the cigarette cartridge 140 is discharged through the second opening 160. Size and structure of the gap 170 are not limited herein, and the gap 170 only needs to meet requirements that the airflow can pass through.

It can be seen that, in the mode, the gap 170 is defined between the cigarette cartridge 140 and the inner wall of the cigarette cartridge bin 120 to enable the airflow to pass through, so that atomizing airflow 400 passing through the cigarette cartridge 140 and switch airflow 500 passing through the microphone 250 respectively flow out from two independent airflow channels. According to the mode, after the air channel in the cigarette cartridge 140 is blocked by the tobacco tar, the switch airflow 500 of the microphone 250 still flows out from the channel of the switch airflow 500 generated by the gap 170, so that the microphone 250 further senses the airflow, and then the PCB 210 still controls the cigarette cartridge 140 to work to atomize the tobacco tar to open the blocked channel. In other words, the mode well ensures that the cigarette cartridge 140 cannot be blocked by the tobacco tar, and the atomizer will not stop working after the air channel in the cigarette cartridge 140 is blocked by the tobacco tar.

Furthermore, in order to enable the airflow discharged by the air outlet hole 270 to enter the gap 170 and guarantee smoothness of the switch airflow 500. An extending portion opening 180 is further extended to one side of a position, with respect to the cigarette cartridge bin 120, of the first opening 150. The extending portion opening 180 is communicated with the cigarette cartridge bin 120.

Specifically, when the base 200 is disposed on the housing body 100, the air outlet hole 270 is communicated with the extending portion opening 180, and the airflow exhausted by the air outlet hole 270 enters the gap 170 through the extending portion opening 180.

Referring to FIG. 2, the housing body 100 includes a support 190a and a housing 190b. The battery bin 110 and the cigarette cartridge bin 120 are respectively disposed on the support 190a. The housing 190b is sleeved on the support 190a, and the housing 190b is configured to surround the support 190a.

According to the above mode, the housing body 100 is divided into the independent support 190a and the independent housing 190b, on one hand, processing of structures such as the battery bin 110, a cabin of the cigarette cartridge 140, the first opening 150, and the second opening 160 are facilitated, and on the other hand, integrity of the housing body 100 with the cigarette holder 300 and the base 200 after installation is guaranteed.

Furthermore, the cigarette cartridge bin 120 and/or the battery bin 110 are disposed as semi-surrounding structures. On one hand, the semi-surrounding structures facilitate formation of the gap 170, and on the other hand, the semi-surrounding structures facilitate installation of the battery 130. Meanwhile, the semi-surrounding structures enable the battery bin 110 and the cigarette cartridge bin 120 to be compatible with the batteries 130 or the cigarette cartridges 140 of different sizes and models.

Referring to FIG. 2, a sealing ring 280 is disposed on an outer wall of the base 200. When the base 200 is disposed on the housing body 100, the sealing ring 280 is located between the outer wall of the base 200 and an inner wall of the housing 190b, which plays a role in sealing a joint of the base 200 and the housing body 100, prevents oil leakage and prevents water or other impurities from entering the cavity. And the sealing ring 280 is located between the outer wall of the base 200 and the inner wall of the housing 190b, which plays a role in horizontally extruding the sealing ring 280, and improves sealing effects.

Referring to FIG. 2, a charging port 290a and/or a key 290b are further disposed on the base 200. The charging port 290a and/or the key 290b are respectively electrically connected to the PCB 210. The charging port 290a is configured to charge the battery 130, and the key 290b is configured to control the PCB 210.

Furthermore, the air inlet hole 240 is defined between an outer wall of the charging port 290a and/or the key 290b and the base 200.

That is, a gap is defined between the outer wall of the charging port 290a and/or the key 290b and the base 200, and the gap serves as the air inlet hole 240. According to the structure, a through hole does not need to be additionally defined on the base 200 to serve as the air inlet hole 240, which achieves a function of hiding the air inlet hole 240.

The above descriptions are merely preferred embodiments of the present disclosure, and are not intended to limit the present disclosure. Any modification, equivalent replacement, improvement and the like made within spirit and principle of the present disclosure shall fall within a scope of protection of the present disclosure.

What is claimed is:

1. An electronic cigarette atomizer, comprising:
a housing body;
a cigarette holder; and
a base;
wherein a battery bin and a cigarette cartridge bin are respectively disposed in the housing body, a battery is detachably disposed in the battery bin, a first opening is defined at a first end of the housing body, the first opening is communicated with the battery bin and the cigarette cartridge bin, a second opening is defined at a second end of the housing body, the second opening is communicated with the cigarette cartridge bin;
the cigarette holder is disposed at one end, close to the second opening, of the housing body, the cigarette holder is communicated with the second opening;
a printed circuit board (PCB) is disposed in the base, an ejector pin is connected to the PCB, the ejector pin protrudes out of the base, a mounting hole is further defined on the base, the mounting hole is configured to mount a cigarette cartridge, an air inlet hole is further defined on the base, the air inlet hole is communicated with the mounting hole;
when the cigarette cartridge is disposed in the mounting hole, the cigarette cartridge is in contact with the PCB; and
when the base is disposed at one end, close to the first opening, of the housing body, the ejector pin is in contact with the battery, and the cigarette cartridge is just located in the cigarette cartridge bin.

2. The electronic cigarette atomizer according to claim 1, wherein a magnet is disposed on the housing body and/or the base, and the base is detachably connected to the housing body through the magnet.

3. The electronic cigarette atomizer according to claim 1, wherein a cavity is defined in the base, the cavity is communicated with the air inlet hole and the mounting hole; and
the electronic cigarette atomizer further comprises a microphone, the microphone is disposed in the cavity, the microphone is electrically connected to the PCB, and the microphone is configured to sense airflow entering the air inlet hole.

4. The electronic cigarette atomizer according to claim 3, wherein a mounting groove is defined in the cavity of the base, the microphone is disposed in the mounting groove;
an air outlet hole is defined on the base, the air outlet hole is communicated with the mounting groove; when the base is disposed on the housing body, the air outlet hole is communicated with the first opening with respect to the cigarette cartridge bin; a part of the airflow entering from the air inlet hole is discharged out of the base from the air outlet hole after passing through the microphone; and
a gap is defined between a side wall of the cigarette cartridge and an inner wall of the cigarette cartridge bin, and the gap is communicated with the first opening and the second opening.

5. The electronic cigarette atomizer according to claim 4, wherein an extending portion opening is further defined in a position, with respect to the cigarette cartridge bin, of the first opening; the extending portion opening is communicated with the cigarette cartridge bin, when the base is disposed on the housing body, the air outlet hole is communicated with the extending portion opening, and the airflow exhausted by the air outlet hole enters the gap through the extending portion opening.

6. The electronic cigarette atomizer according to claim 1, wherein the housing body comprises a support and a housing;
the battery bin and the cigarette cartridge bin are respectively disposed on the support, the cigarette cartridge bin is of a full-surrounding structure, the battery bin is of a semi-surrounding structure; and
the housing is sleeved on the support, and the housing is configured to surround the support.

7. The electronic cigarette atomizer according to claim 6, wherein a sealing ring is disposed on an outer wall of the base, and when the base is disposed on the housing body, the sealing ring is located between the outer wall of the base and an inner wall of the housing.

8. The electronic cigarette atomizer according to claim 1, wherein a charging port and/or a key are further disposed on the base, and the charging port and/or the key are respectively and electrically connected to the PCB.

9. The electronic cigarette atomizer according to claim 8, wherein the air inlet hole is defined between an outer wall of the charging port and/or the key and the base.

10. The electronic cigarette atomizer according to claim 1, wherein the cigarette holder is connected to the housing body in a buckled mode.

11. The electronic cigarette atomizer according to claim 2, wherein a cavity is defined in the base, the cavity is communicated with the air inlet hole and the mounting hole; and
the electronic cigarette atomizer further comprises a microphone, the microphone is disposed in the cavity, the microphone is electrically connected to the PCB, and the microphone is configured to sense airflow entering the air inlet hole.

12. The electronic cigarette atomizer according to claim 2, wherein a charging port and/or a key are further disposed on the base, and the charging port and/or the key are respectively electrically connected to the PCB.

13. The electronic cigarette atomizer according to claim 5, wherein a charging port and/or a key are further disposed on the base, and the charging port and/or the key are respectively electrically connected to the PCB.

14. The electronic cigarette atomizer according to claim 7, wherein a charging port and/or a key are further disposed on the base, and the charging port and/or the key are respectively electrically connected to the PCB.
